(19) United States
(12) Patent Application Publication
(10) Pub. No.: US 2012/0294041 A1
(43) Pub. Date: Nov. 22, 2012

(54) BACKLIGHT MODULE WITH THERMAL INSULATION

(75) Inventor: Jian-fa Huang, Guangdong (CN)

(73) Assignee: SHENZHEN CHINA STAR OPTOELECTRONICS TECHNOLOGY CO., LTD., Shenzhen (CN)

(21) Appl. No.: 13/203,644

(22) PCT Filed: Jun. 2, 2011
(86) PCT No.: PCT/CN11/75227

§ 371 Date: Aug. 26, 2011

(30) Foreign Application Priority Data
May 16, 2011 (CN) 201120155687.8

(51) Int. Cl. G09F 13/08; F21V 8/00

(52) U.S. Cl. 362/612; 362/613; 362/611

(57) ABSTRACT

The present invention discloses a backlight module with thermal insulation. The backlight module mainly includes a frame assembly, a light-emitting source and thermal-insulating material. The frame assembly has a backlight cavity defined inside the frame assembly for placing an optical component. The light-emitting source is mounted at a side of the frame assembly. The thermal-insulating material is mounted on an internal surface of the frame assembly and insulates heat conducted to the internal surface of the frame assembly from entering the backlight cavity. Since the thermal-insulating material insulates the heat of the light-emitting source from entering the backlight cavity via the frame assembly, the present invention effectively lowers the temperature in the backlight cavity and reduces the aging speed of the optical component in the backlight cavity.

### FIELD OF THE INVENTION

The present invention relates to a backlight module, and more particularly to a backlight module with thermal insulation.

### BACKGROUND OF THE INVENTION

A backlight module is a basic component of a liquid crystal display device that uses a light guide plate to guide lights of a backlight source to a surface light source with uniform brightness. Generally, a light source for using in a backlight module includes cold cathode fluorescent lamps and light emitting diodes (LEDs). Since the light emitting diodes have advantages of small size and long work life, the light emitting diodes gradually replace the cold cathode fluorescent lamps in the market.

In the present backlight module using LEDs as a backlight source, heat generated by the LED backlight source is conducted to exterior via a back board to be dissipated into air, so at to achieve an object of heat-dissipation. However, since the back board often directly contacts with the optical components, such as a light guide plate disposed in a backlight cavity, some heat generated by the LED backlight source will be conducted into the backlight cavity via the back board. Being placed in a high temperature environment for a long time may cause the aging of the optical components. And stress caused by thermal expansion and contraction will deform the optical components and further affect optical properties of the optical components.

The present design of heat-dissipation for the backlight module only considers how the effect of dissipating heat to exterior is, but ignores the damage brought by heat accumulated in the backlight cavity.

Hence, it is necessary to provide a backlight module with thermal insulation to overcome the problems existing in the conventional technology.

### SUMMARY OF THE INVENTION

A primary object of the invention is to provide a backlight module with thermal insulation that can prevent heat from be conducting to an internal surface of a frame assembly and spreading into a backlight cavity, so as to further lower the temperature in the backlight cavity.

To achieve the above object, the present invention provides a backlight module with thermal insulation, and the backlight module comprises:

a frame assembly having a backlight cavity defined inside the frame assembly;

a light-emitting source disposed at a side of the frame assembly;

at least one optical component disposed in the backlight cavity; and

thermal-insulating material disposed on an internal surface of the frame assembly and insulating heat of the light-emitting source which is conducted through the internal surface of the frame assembly from entering the backlight cavity.

In one embodiment of the present invention, the at least one optical component is a light guide plate.

In one embodiment of the present invention, the thermal-insulating material is plastic or rubber.

In one embodiment of the present invention, the frame assembly includes a frame body and an aluminum substrate, wherein the aluminum substrate is mounted on a sidewall of the frame body, the light-emitting source is mounted on the aluminum substrate.

In one embodiment of the present invention, the frame assembly includes a frame body and a heat-dissipating backboard; an inner surface of the heat-dissipating backboard is attached to a back of the frame body; the light-emitting source is disposed on the inner surface of the heat-dissipating backboard; and the thermal-insulating material is mounted on an inner surface of the frame body and corresponds to an overlapping area of the heat-dissipating backboard and the frame body.

In one embodiment of the present invention, the light-emitting source has a circuit board and multiple light-emitting units mounted on the circuit board, and the circuit board is mounted on the aluminum substrate.

In one embodiment of the present invention, the light-emitting source has a circuit board and multiple light-emitting units mounted on the circuit board, and the circuit board is mounted on the inner surface of the heat-dissipating backboard.

In one embodiment of the present invention, the thermal-insulating material further extends to an inner surface of the frame body.

In one embodiment of the present invention, the light-emitting units are light-emitting diodes.

The present invention mainly mounts the thermal-insulating material on the inner surface of the frame assembly, so as to insulate heat of the light-emitting source from conducting from the inner surface of the frame assembly to the backlight cavity, and thereby effectively reduce the temperature in the backlight cavity and lower the aging speed of the optical components placed in the backlight cavity.

### DESCRIPTION OF THE DRAWINGS

FIG. 1 is a cross-sectional side view of a first embodiment of a backlight module with thermal insulation in accordance with the present invention;

FIG. 2 is a perspective view of the first embodiment of the backlight module with thermal insulation in accordance with the present invention;

FIG. 3 is a perspective view of a second embodiment of the backlight module with thermal insulation in accordance with the present invention; and

FIG. 4 is a partial perspective view of a third embodiment of the backlight module with thermal insulation in accordance with the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

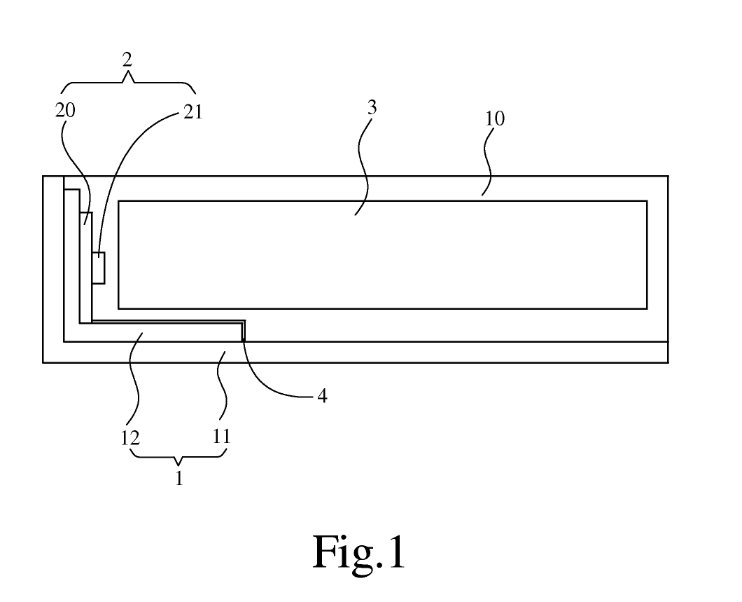

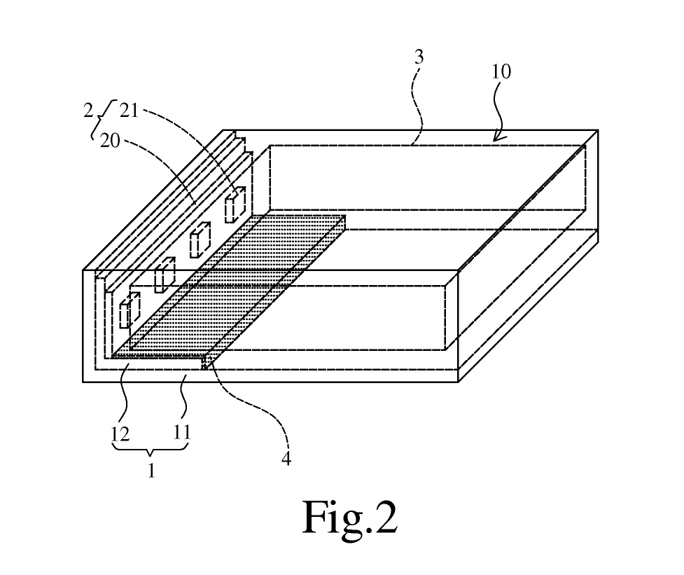

With reference to FIGS. 1 and 2, FIGS. 1 and 2 are cross-sectional side view and perspective view of a first embodiment of a backlight module with thermal insulation in accordance with the present invention. The backlight module mainly comprises a frame assembly 1, a light-emitting source 2, at least one optical component 3 and thermal-insulating material 4.

The frame assembly 1 has a backlight cavity 10, and the backlight cavity 10 is defined inside the frame assembly 1. In this embodiment, the frame assembly 1 further has a frame body 11 and an aluminum substrate 12, wherein the aluminum substrate 12 is mounted on a sidewall of the frame body 11, and the light-emitting source 2 is mounted on the aluminum substrate 12. In details, the aluminum substrate 12 is an L-shaped plate body. The light-emitting source 2 has a circuit board 20 and multiple light-emitting units 21 mounted on the circuit board 20. The circuit board 20 is mounted on the aluminum substrate 12. The light-emitting units 21 are preferably light-emitting diodes.

The at least one optical component 3 is disposed in the backlight cavity 10 and may be a light guide plate or a combination of a light guide plate and other optical films, but is not limited thereto.

The thermal-insulating material 4 is disposed on an internal surface of the frame assembly 1. In this embodiment, the thermal-insulating material 4 is mounted on an internal surface of the aluminum substrate 12. The thermal-insulating material 4 is preferably plastic or rubber, but is not limited thereto.

Since the thermal-insulating material 4 is mounted on the internal surface of the aluminum substrate 12, heat generated by the light-emitting source 2 mounted on the aluminum substrate 12 will be insulated by the thermal-insulating material 4 so that heat diffused into the backlight cavity 10 via the internal surface of the aluminum substrate 12 can be reduced. Hence, the temperature in the backlight cavity 10 will not be too high to cause aging or deformation of the optical component 3.

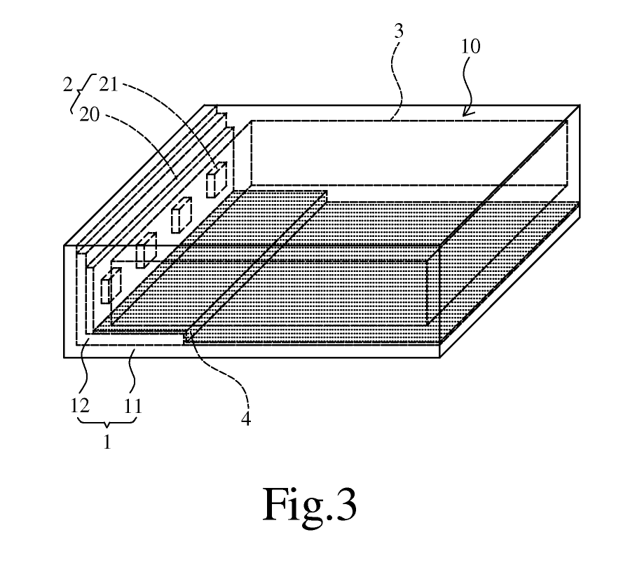

With further reference to FIG. 3, FIG. 3 is a perspective view of a second embodiment of the backlight module with thermal insulation in accordance with the present invention. The difference that the second embodiment differs from the first embodiment is that: the thermal-insulating material 4 further extends to an inner surface of the frame body 11, so as to further insulate the heat conducted to the frame body 11 from entering the backlight cavity 10 via the internal surface of the frame body 11.

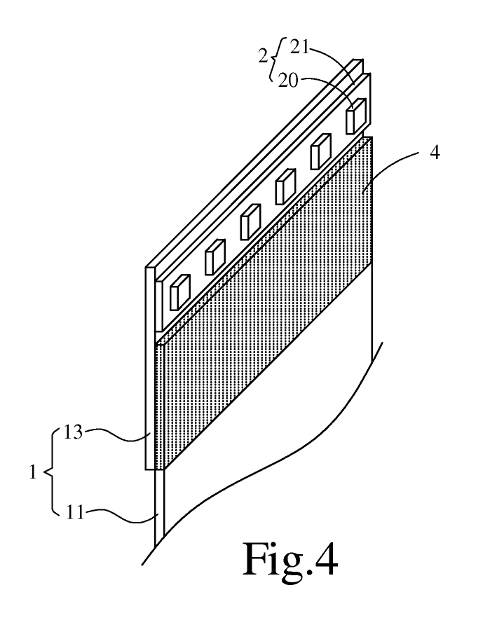

With further reference to FIG. 4, FIG. 4 is a partial perspective view of a third embodiment of the backlight module with thermal insulation in accordance with the present invention. The third embodiment discloses another heat-dissipating structure of the backlight module. In the third embodiment, the frame assembly 1 includes the frame body 11 and a heat-dissipating backboard 13. An inner surface of the heat-dissipating backboard 13 is attached to a back of the frame body 11. Furthermore, the light-emitting source 2 is disposed on the inner surface of the heat-dissipating backboard 13. In details, the circuit board 20 of the light-emitting source 2 is mounted on the inner surface of the heat-dissipating backboard 13. The heat-dissipating backboard 13 is used to absorb heat generated by the light-emitting source 2 mounted thereon and diffuse the heat out of the backlight module. The thermal-insulating material 4 is mounted on an inner surface of the frame body 11 and corresponds to an overlapping area of the heat-dissipating backboard 13 and the frame body 11.

The thermal-insulating material 4 that corresponds to the overlapping area of the heat-dissipating backboard 13 and the frame body 11 can prevent the heat from being conducted from the heat-dissipating backboard 13 to the frame body 11, and also is helpful for reducing temperature in the backlight cavity 10.

In conclusion, comparing with the conventional technology that does not mount thermal-insulating material on the frame assembly, the present invention correspondingly mounts thermal-insulating material on the frame assembly of the backlight module, which corresponds to the area that might cause higher temperature in the backlight cavity, so as to insulate heat from entering the backlight cavity via the internal surface of the frame assembly. Therefore, the present invention can effectively lower the temperature in the backlight cavity to cause the temperature distribution inside the backlight cavity to be more uniform, and thereby lower the speed of aging of the optical component or prevent the optical component from being deformed by the force caused by thermal expansion and contraction.

The present invention has been described with a preferred embodiment thereof and it is understood that many changes and modifications to the described embodiment can be carried out without departing from the scope and the spirit of the invention that is intended to be limited only by the appended claims.

1. A backlight module with thermal insulation, characterized in that: the backlight module comprising:
a frame assembly having a backlight cavity defined inside the frame assembly, a frame body and an aluminum substrate, wherein the aluminum substrate is mounted on a sidewall of the frame body;
a light-emitting source mounted on the aluminum substrate;
a light guide plate disposed in the backlight cavity; and
thermal-insulating material disposed on an internal surface of the frame assembly and insulating heat of the light-emitting source which is conducted through the internal surface of the frame assembly from entering the backlight cavity.

2. A backlight module with thermal insulation, characterized in that: the backlight module comprising:
a frame assembly having a backlight cavity defined inside the frame assembly;
a light-emitting source disposed at a side of the frame assembly;
at least one optical component disposed in the backlight cavity; and
thermal-insulating material disposed on an internal surface of the frame assembly and insulating heat of the light-emitting source which is conducted through the internal surface of the frame assembly from entering the backlight cavity.

3. The backlight module with thermal insulation as claimed in claim 2, characterized in that: the at least one optical component is a light guide plate.

4. The backlight module with thermal insulation as claimed in claim 2, characterized in that: the thermal-insulating material is plastic or rubber.

5. The backlight module with thermal insulation as claimed in claim 2, characterized in that: the frame assembly includes a frame body and an aluminum substrate, wherein the aluminum substrate is mounted on a sidewall of the frame body, the light-emitting source is mounted on the aluminum substrate.

6. The backlight module with thermal insulation as claimed in claim 2, characterized in that: the frame assembly includes a frame body and a heat-dissipating backboard; an inner surface of the heat-dissipating backboard is attached to a back of the frame body; the light-emitting source is disposed on the inner surface of the heat-dissipating backboard; and the thermal-insulating material is mounted on an inner surface of the frame body and corresponds to an overlapping area of the heat-dissipating backboard and the frame body.

7. The backlight module with thermal insulation as claimed in claim 5, characterized in that: the light-emitting source has a circuit board and multiple light-emitting units mounted on the circuit board, and the circuit board is mounted on the aluminum substrate.

8. The backlight module with thermal insulation as claimed in claim 6, characterized in that: the light-emitting source has a circuit board and multiple light-emitting units mounted on the circuit board, and the circuit board is mounted on the inner surface of the heat-dissipating backboard.

9. The backlight module with thermal insulation as claimed in claim 5, characterized in that: the thermal-insulating material further extends to an inner surface of the frame body.

10. The backlight module with thermal insulation as claimed in claim 7, characterized in that: the light-emitting units are light-emitting diodes.

11. The backlight module with thermal insulation as claimed in claim 8, characterized in that: the light-emitting units are light-emitting diodes.
